(19) United States
(12) Patent Application Publication
(10) Pub. No.: US 2014/0261203 A1
(43) Pub. Date: Sep. 18, 2014

(54) Portable Animal Feeder

(71) Applicant: DOSKOCIL MANUFACTURING COMPANY, INC., Arlington, TX (US)

(72) Inventors: Jack W. Renforth, AZLE, TX (US); Ann Hanson, Ionia, MI (US); Doug Golenz, Littleton, CO (US)

(73) Assignee: DOSKOCIL MANUFACTURING COMPANY, INC., Arlington, TX (US)

(21) Appl. No.: 14/045,043

(22) Filed: Oct. 3, 2013

Related U.S. Application Data
(60) Provisional application No. 61/790,438, filed on Mar. 15, 2013.

(51) Int. Cl. A01K 5/01

(52) U.S. Cl. CPC A01K 5/0114
USPC 119/61.56

(57) ABSTRACT

An animal feeder includes a pair of food containers and a base comprising a pair of base members upon which the pair of food containers are situated. The base members are structured to be movable between a deployed position and a collapsed position. In the deployed position, the food containers are situated adjacent one another in a first plane. In the collapsed position, the food containers at least partially overlie one another in a second plane that is transverse to the first plane. The animal feeder also includes a pair of leg elements upon which the base members are situated. The leg elements are structured to be movable between an extended position, in which the leg elements support the base members in the deployed position, and a retracted position. In the retracted position, the base members are in the collapsed position.

### CROSS-REFERENCE TO RELATED APPLICATIONS

This application claims priority from and claims the benefit of U.S. Provisional Patent Application Ser. No. 61/790,438, filed Mar. 15, 2013.

### BACKGROUND OF THE INVENTION

1. Field of the Invention

The disclosed concept pertains generally to animal feeders and, more particularly, to animal feeders that are more easily transported and stored.

2. Description of the Prior Art

Animal feeders are well known. One common type is an elevated animal feeder having food and liquid containers that an animal can access and which are situated in a position elevated above a floor. Known elevated animal feeders take up significant space and are difficult for owners to transport and store. There is a need for an improved animal feeder.

### SUMMARY OF THE INVENTION

These needs and others are met by the disclosed concept, which is directed to an animal feeder that is more easily transported and stored.

In accordance with one aspect of the disclosed concept, an animal feeder can be generally stated as including a pair of food containers and a base that includes a pair of base members upon which the pair of food containers are situated. The pair of base members are structured to be movable between a deployed position and a collapsed position. When the pair of base members are in the deployed position, the pair of food containers are situated adjacent one another in a first plane. When the pair of base members are in the collapsed position, the pair of food containers at least partially overlie one another in a second plane transverse to the first plane. The animal feeder additionally includes a pair of leg elements upon which the pair of base members are situated, the pair of leg elements being structured to be movable between an extended position and a retracted position. When the pair of leg elements are in the extended position, the pair of leg elements are structured to support the pair of base members in the deployed position. The pair of leg elements are in the retracted position when the pair of base members are in the collapsed position.

### BRIEF DESCRIPTION OF THE DRAWINGS

A full understanding of the disclosed concept can be gained from the following description of the preferred embodiments when read in conjunction with the accompanying drawings in which:

FIG. 1 is a perspective view of an animal feeder in accordance with an exemplary embodiment of the disclosed concept.

FIG. 2 is a side view of the animal feeder of FIG. 1.

FIG. 3 is a side view of the animal feeder of FIG. 1 with base members in a collapsed position.

FIG. 4 is a perspective view of the animal feeder of FIG. 1 with base members in the collapsed position.

FIG. 5 is a perspective view of a food container of the animal feeder of FIG. 1 in an expanded position.

FIG. 6 is a side view of the food container of FIG. 5.

FIG. 7 is a side view of the food container of FIG. 5 in an unexpanded position.

FIG. 8 is a perspective view of an animal feeder in accordance with an alternative embodiment of the disclosed concept.

FIG. 9 is a perspective view of a food container of the animal feeder of FIG. 8.

### DESCRIPTION OF THE PREFERRED EMBODIMENTS

As will be discussed below in connection with FIGS. 1 through 9, transport and storage of an animal feeder 2, 102 are improved by enabling the animal feeder 2, 102 to move between a plurality of positions. FIG. 1 shows an examplary animal feeder 2 in accordance with the disclosed concept. As seen, the animal feeder 2 has two food containers 4, 6, a base 8 which has a pair of base members 10, 12, and a pair of leg elements 14, 16 upon which the base members 10, 12 are situated. The base members 10, 12 are structured to be movable between a deployed position, seen in FIGS. 1 and 2 and in phantom lines in FIG. 3, and a collapsed position, seen in FIGS. 3 and 4. In the collapsed position, an animal owner advantageously encounters less difficulty in transporting or storing the animal feeder 2.

The base members 10, 12 of the animal feeder 2, upon which the food containers 4, 6 are situated, may be made of any material suitable to support the food containers 4, 6 (e.g., without limitation, metal, wood, or constructed of a composition containing a monomer, polymer, or mixture thereof). Referring to FIGS. 1 through 4, the base 8 further comprises a hinge mechanism 42, and the base members 10, 12 are coupled to each other by the hinge mechanism 42. The hinge mechanism 42 includes a rod (not shown) having a diameter that is preferably between 1/32″ and ¾″, and that is received by the base members 10, 12. The base members 10, 12 pivot, indicated by arrows in FIG. 3, between the deployed position and the collapsed position. Although the animal feeder 2 has been described in association with a hinge mechanism 42, it is within the scope of the disclosed concept for the base members 10, 12 to be coupled to each other by any suitable mechanism (e.g., without limitation, a tongue and groove mechanism).

Referring to FIG. 3, the food containers 4, 6 are situated adjacent one another (shown in phantom lines) and are disposed in a first plane 18 when the base members 10, 12 are in the deployed position. However, it is within the scope of the disclosed concept for the food containers 4, 6 to not be situated adjacent one another in the first plane 18 in the deployed position (e.g., the food containers 4, 6 may each have a top edge that is located in a plane (not shown), the planes being at varying angles with respect to each other when the base members 10, 12 are in a deployed position). The base members (in other embodiments that are not shown) may also have a substantially curved upper surface and/or a substantially curved lower surface. When the base members 10, 12 are in the collapsed position, the food containers 4, 6 partially overlie one another in a second plane 20 that is generally transverse to the first plane 18.

In addition, the base 8 further comprises a first locking mechanism 44, seen in FIGS. 1 through 4, that is structured to retain the base members 10, 12 in the deployed position. The first locking mechanism 44 may be any suitable mechanism known in the art (e.g., without limitation, may be molded to the base members 10, 12 and folded under to retain the base members 10, 12 in the deployed position. Seen in FIGS. 1 through 4, the base 8 further comprises a second locking mechanism 46 that is structured to retain the base members 10, 12 in the collapsed position. The second locking mechanism 46 may be, for example and without limitation, a latch.

In addition to having moving base members 10, 12, the leg elements 14, 16 of the animal feeder 2 are structured to be movable between an extended position, shown in FIGS. 1 and 2, and a retracted position, indicated with dashed lines in FIG. 2. In the extended position, the leg elements 14, 16 are structured to support the base members 10, 12 in the deployed position. When the base members 10, 12 are in the collapsed position, the leg elements 14, 16 are in the retracted position. The base members 10, 12 each contain a number of cavities 48, and when the base members 10, 12 are in the collapsed position, the leg elements 14, 16 are disposed in the cavities 48.

The leg elements 14, 16 may be made of any material suitable to support the weight of the animal feeder 2 (e.g., without limitation, metal, wood, or constructed of a composition containing a monomer, polymer, or mixture thereof). The leg elements 14, 16 are pivotably coupled to the base members 10, 12 and, indicated with arrows in FIG. 2, the leg elements 14, 16 are pivotable between the extended position and the retracted position. However, the leg elements 14, 16 may move between the extended position and the retracted position by any suitable mechanism known in the art (e.g., without limitation, the leg elements 14, 16 may separate from the base members 10, 12 and be stored in the cavities 48). Additionally, the disclosed concept is not limited to the leg elements shown. For example and without limitation, the leg elements may comprise four individual posts.

Referring to FIGS. 5 through 7, the food container 4 is shown. The food container 4 is structured to be movable between an expanded position, seen in FIGS. 5, 6, and in phantom lines in FIG. 7, and an unexpanded position, seen in FIG. 7. In the expanded position, the food container 4 has a first depth 22 that is greater than a second depth 24 of the food container 4 in the unexpanded position. The food container 4 comprises a number of lateral elements (two lateral elements 28, 30 are indicated in FIGS. 6 and 7). Each of the lateral elements 28, 30 includes a first component 32, 36 and a second component 34, 38. The first components 32, 36 each have an end 32′, 36′ that is coupled to a corresponding end 34′, 38′ of the second components 34, 38. The ends 32′, 34′ are generally located in a third plane 40 and the ends 36′, 38′ are generally located in a fourth plane 41. The third plane 40 and fourth plane 41 are substantially parallel to the first plane 18 (FIG. 3). However, it is within the scope of the disclosed concept for the third plane 40 and the fourth plane 41 to be at other angles with respect to the first plane 18.

The food container 4 is generally a telescoping body. Referring to FIG. 7, when the food container 4 moves between the expanded position and the unexpanded position, the lateral elements 28, 30 undergo deflection. When the lateral elements 28, 30 undergo deflection and the food container 4 is in the unexpanded position, the lateral element 30 becomes nested within the lateral element 28. Although the lateral element 30 in FIG. 7 is substantially nested within the lateral element 28, it is within the scope of the disclosed concept for the lateral element 30 to be partially nested (not shown) within the lateral element 28. The food container 4 is made of any material suitable for the lateral elements 28, 30 to undergo deflection (e.g., without limitation, in part or in whole from silicon). However, it is within the scope of the disclosed concept for other embodiments of the food containers (not shown) to be substantially rigid, being made from any material suitable to contain a liquid, such as metal or a rigid material constructed of a composition containing a monomer, polymer, or mixture thereof. Additionally, the disclosed concept is not limited to lateral elements 28, 30 comprising first components 32, 36 and second components 34, 38. The lateral elements in other embodiments (not shown) may assume any alternative configuration suitable for nesting (e.g., without limitation, lateral elements consisting only of one component).

Indicated in FIG. 5, the food container 6 is a telescoping body identical to the food container 4. However, it is within the scope of the disclosed concept for the food containers in other embodiments (not shown) to be a different size, shape, and/or be made of different materials. Additionally the disclosed concept is not limited to two food containers 4, 6. For example and without limitation, an animal feeder (not shown) may comprise one large food container situated on one of the base members and a plurality of food containers situated on the other base member, although other combinations are possible. The food containers 4, 6 may also be fixedly coupled to the base members 10, 12, or, may be removably coupled to the base members 10, 12.

The animal feeder 2 described in FIGS. 1 through 7 has been described in association with food containers 4, 6 that comprise lateral elements 28, 30 that are substantially circular shaped. FIGS. 8 and 9 show an alternative, non-limiting embodiment of the disclosed concept, in which an animal feeder 102 comprises a pair of food containers 104, 106 that comprise lateral elements (two lateral elements 128, 130 of food container 104 are indicated in FIG. 9) that are substantially rectangular shaped. As seen, the animal feeder 102 is substantially similar to the animal feeder 2.

The animal feeder 102 further includes a base 108 that includes a pair of base members 110, 112, as well as leg elements 114, 116 upon which the base members 110, 112 are situated. Similar to the food containers 4, 6 of the animal feeder 2, the food container 104 is a telescoping body, whereby the lateral elements 128, 130 undergo deflection. The food containers 104, 106 can be made of any material suitable for deflection (e.g., without limitation, in part or in whole from silicon). The base members 110, 112 and leg elements 114, 116 are also movable similar to and can be made from the same materials as the base members 10, 12 and leg elements 14, 16 of the animal feeder 2. As such, the animal feeder 102 is advantageous for substantially the same reasons as the animal feeder 2.

The specific elements that have been illustrated in the Figures and described in the specification are simply exemplary embodiments of the disclosed concept and have been provided as non-limiting examples solely for the purpose of illustration. The embodiments were chosen and described in order to best explain the principles of the invention and its practical application to thereby enable others skilled in the art to best utilize the invention in various embodiments and various modifications. It is intended that the appended claims be construed to include other alternative embodiments of the invention except insofar as limited by the prior art. Additionally, the size of the disclosed animal feeder is not limited to the size of a particular animal. For example and without limitation, the disclosed concept provides for animal feeders suitable for a small house cat to animal feeders suitable for a large dog, such as a Great Dane.

As employed herein, the term “number” means one or an integer greater than one (i.e., a plurality). Furthermore, as employed herein, the statement that two or more parts are “coupled” together means that the parts are joined together either directly or joined through one or more intermediate parts.

What is claimed is:

1. An animal feeder comprising:
a pair of food containers;
a base comprising a pair of base members upon which the pair of food containers are situated, the pair of base members being structured to be movable between a deployed position and a collapsed position, wherein in the deployed position the pair of food containers are situated adjacent one another in a first plane and in the collapsed position the pair of food containers at least partially overlie one another in a second plane transverse to the first plane; and
a pair of leg elements upon which the pair of base members are situated, the pair of leg elements being structured to be movable between an extended position and a retracted position, wherein in the extended position the pair of leg elements are structured to support the pair of base members in the deployed position, the pair of leg elements being in the retracted position when the pair of base members are in the collapsed position.

2. The animal feeder of claim 1 wherein at least one food container is structured to be movable between an expanded position and an unexpanded position, wherein in the expanded position the at least one food container has a first depth and in the unexpanded position the at least one food container has a second depth, the first depth being greater than the second depth.

3. The animal feeder of claim 2 wherein the at least one food container is a telescoping body, the telescoping body comprising a number of lateral elements that undergo deflection in moving between the expanded position and the unexpanded position.

4. The animal feeder of claim 3 wherein the number of lateral elements each comprise a first component having an end, and a second component having an end, the ends being coupled together.

5. The animal feeder of claim 4 wherein the number of lateral elements comprise a first lateral element and a second lateral element, the second lateral element being nested at least partially within the first lateral element when the telescoping body is in the unexpanded position.

6. The animal feeder of claim 5 wherein at least one of the ends of the first lateral element and the ends of the second lateral element is disposed in a third plane, the third plane being substantially parallel to the first plane.

7. The animal feeder of claim 6 wherein at least one of the first lateral element and the second lateral element is substantially circular shaped.

8. The animal feeder of claim 7 wherein the telescoping body is made at least in part of silicon.

9. The animal feeder of claim 8 wherein the second lateral element is substantially nested within the first lateral element when the telescoping body is in the unexpanded position.

10. The animal feeder of claim 9 wherein the other food container is another telescoping body substantially similar to the at least one food container.

11. The animal feeder of claim 6 wherein at least one of the first lateral element and the second lateral element is substantially rectangular shaped.

12. The animal feeder of claim 11 wherein the telescoping body is made at least in part of silicon.

13. The animal feeder of claim 12 wherein the second lateral element is substantially nested within the first lateral element when the telescoping body is in the unexpanded position.

14. The animal feeder of claim 13 wherein the other food container is another telescoping body substantially similar to the at least one food container.

15. The animal feeder of claim 1 wherein the base further comprises a hinge mechanism, the pair of base members being coupled to each other by the hinge mechanism and being structured to pivot between the deployed position and the collapsed position.

16. The animal feeder of claim 15 wherein the base further comprises a locking mechanism, the locking mechanism being structured to retain the pair of base members in the deployed position.

17. The animal feeder of claim 15 wherein the base further comprises a locking mechanism, the locking mechanism being structured to retain the pair of base members in the collapsed position.

18. The animal feeder of claim 1 wherein the pair of leg elements are pivotably coupled to the pair of base members and are structured to pivot between the extended position and the retracted position.

19. The animal feeder of claim 18 wherein the pair of base members each contain a number of cavities, the pair of leg elements being disposed in the cavities when the pair of base members are in the collapsed position.

20. The animal feeder of claim 1 wherein at least one food container is removably coupled to a corresponding one of the pair of base members.
